(19) United States
(12) Patent Application Publication
(10) Pub. No.: US 2004/0112518 A1
(43) Pub. Date: Jun. 17, 2004

(54) Polymer bonding by means of plasma activation

(76) Inventors: Joel Stephane Rossier, Saillon (CH); Frederic Reymond, La Conversion (CH); Hubert HuguesGirault, Ropraz (CH)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/475,584

(22) PCT Filed: May 10, 2002
(86) PCT No.: PCT/EP02/05989

(30) Foreign Application Priority Data
May 10, 2001 (GB) 0111438.8

(51) Int. Cl. B32B 31/00

(52) U.S. Cl. 156/272.2

(57) ABSTRACT

A low temperature method of bonding two polymer sheets (2, 3) without adhesive, at least one of said polymer sheets comprising a microstructure (1) or a network of microstructures, comprises the steps of treating at least a portion of one surface of one of said polymer sheets by using a cold plasma or a laser beam so as to physically activate said portion at low temperature, placing the two polymer sheets in contact, with the activated portion of said one sheet in contact with the other sheet, and subjecting said sheets to pressure and to a temperature below the melting and/or glass transition temperature of either of said polymer sheets, thereby bonding said sheets and forming a sealed micro-structure and/or network of micro-structures. The method is used to fabricate a micro-analytical device for use in biological and/or chemical applications.

### BACKGROUND OF THE INVENTION

The present invention relates to a method for the bonding of polymer materials without the need of adhesive or excessive temperature, and a micro-fluidic device fabricated using the bonding method of the invention.

Sealing two polymer sheets together has already been achieved by various means such as thermal bonding of low temperature melting polymer (Poly(methyl-methalcrylate), Polystyrene), by addition of an adhesive layer such as polyethylene in order to enable the lamination at low temperature. For example, Ueno et al. (Uesno, K, et al. Chemistry Letters 2000, p 858) could bond two structured polystyrene plates by heating them at 108° C. for 25 min, which is much higher than the glass transition temperature of this polymer. In other cases, the bonding of polymers largely below their melting or even below their glass transition temperature can be realized. The principle is to modify the surface of the polymer in order to create species that can react and possibly cross-link with another polymer layer placed in contact. Such surface treatment has been successfully demonstrated by the use of Corona discharges on Polyethylene terephthalate (PET) and then bonding at 130° C., i.e. far below its melting temperature. [Briggs Din, Practical Surface Analysis, p 388]. This process has also been used for industrial applications [USH0000688, U.S. Pat. No. 5,051,586] in the fiber industry or in the medical device industry. On the other hand, similar activation of the surface can be obtained by oxygen plasma as presented by previous authors [U.S. Pat. No. 5,108,7801 ] to enhance the surface adhesion properties of fibers. A broader application of plasma is used in order to deposit an adhesive layer on the surface of fibers by plasma and ion plating [U.S. Pat. No. 4,756,925]. A method for laminating polymeric sheet material has also been developed which allows the bonding of two polymer sheets at low temperature. [U.S. Pat. No. 4,900,3888] Nevertheless, no evidence has been brought by previous work that the bonding procedure respects the surface state of the polymer. Particularly, no system was presented where two sheets of the same polymer material could be bonded whilst maintaining intact the shallow 2- or 3-D microstructure at the bonded interface.

Bonding inorganic material such as glass or quartz has been studied and well understood for a long time. Indeed, in this case, the principle of the bonding is the condensation of silanol groups placed in contact to each other to form an Si—O—Si covalent bond. Similarly, siloxane polymer can be bonded to glass or other siloxane provided that silanol groups are present on the surface of the plate. In such cases, bonding between siloxane and glass or between siloxane plates is mechanistically not different to the well-understood bonding of glass. Plasma treatment of the siloxane polymer generates silanol groups, which indeed builds a molecular layer of glass. The treatment of organic polymer (hereafter referred to as carbon-based polymer) is more ambiguous and cannot be compared to the silane-based materials. Indeed, after plasma treatement, some functionalities such as alcohol or acid may be generated on the surface but their density and reactivity is not to be compared to that of silanol [F. Bianchi, H. H. Girault, Anal. Chem., 2001, 73, p.829; A. Ros, V. Devaud, H. H. Girault, Chemical Characterisation of Dynamically Photoablated PET Surface for Micro-analytical Applications, submitted]. Therefore, depending on the plasma treatment, hydrophobic, electrostatic interaction and/or covalent bonding may be responsible for the improved adhesion between polymer layers.

The previously cited treatment of organic polymers was developed to improve the bonding of polymer sheets together without considering the microscopic properties of the surface such as the presence of microstructures or of thin patterns, nor the polymer properties such as cristallinity, optical properties, elasticity, shape, conductivity, dielectric properties, and so on. In the present invention, a soft plasma activation procedure is used in order to enable the bonding of polymer layers without distortion of the microscopic properties of the surface.

Furthermore, microanalytical systems were initially fabricated by conventional technologies used in microelectronics. Therefore, the materials of choice have been silicon, glass or quartz, and photochemistry was used to pattern features and chemical etching to fabricate network of channels. Among these materials, glass and quartz remain the first choice because of their inert behavior against aggressive solvents used in chemistry and because of their optical transparency in the UV range. This last property has been of crucial importance for the implementation of very sensitive and performant detection systems based on fluorescence measurement. Nevertheless, an essential feature of the fabrication process with these technologies is the bonding between plates, in order to seal the patterned micro-structures. Two different technologies are used, namely thermal or anodic bonding. Both require a molecularly flat surface of the material layers, and are very intolerant to any defect or dust. These bonding constraints decrease the attractiveness of the whole fabrication process, especially when large structures have to be designed, such as those used in DNA sequencing.

Therefore, more and more effort has been placed in the fabrication of microanalytical devices with other materials, among which plastics substrates are preferred. Whilst some promising fabrication methods have been shown in plastics by laser photoablation, injection molding, embossing and more recently plasma etching, no plastics material could effectively compete with glass in term of optical properties but also in terms of the quality of electroosmotic flow (EOF). Indeed, a stable EOF can be generated if a microchannel in the substrate is homogeneous, meaning that all walls are made of the same material. The microchips are often fabricated in one polymer, while a composite material is laminated over it to seal the microstructure. In other cases, the polymer used has a low glass transition temperature, and bonding by melting the surface is possible. In this case the channels are composed of the same material but may have changed their surface properties because of annealing during the bonding. Furthermore, this is limited to certain polymers and cannot be adapted to every kind of application. Indeed, non-optical detection methods such as electrochemical, NMR (nuclear magnetic resonance) or mass spectrometry are under development. For some applications, different solvents must be used such as acetonitrile or methanol in mass spectrometry. Therefore, the need for materials resistant to solvents becomes even more critical than the optical properties. With this respect, the use of glue, silicone rubber or polyethylene as adhesive layer must be avoided and homogeneous channels (referred to as channels made of one single type polymer) are preferred.

Thus, certain applications necessitate the use of polymer layers that have certain desired properties such as supporting high temperature or aggressive solvent treatment, particularly when microstructures are present on one of the polymer sheets. In such cases, the choice of the appropriate polymer cannot be limited to the property of at least one layer that can bond by melting at low temperature.

### SUMMARY OF THE INVENTION

It is an aim of the present invention to provide a method to bond two polymer sheets (also hereinafter referred to as polymer layers, plates or foils) at a temperature below their melting or glass transition temperature and without use of adhesive, while achieving sealing forces between the two polymer sheets that are strong enough to support contact with solutions and to maintain the properties of the surfaces of the polymer sheets. It is also an aim of the present invention to use this bonding method to fabricate sealed micro-systems made of polymer materials.

The present invention provides a low temperature method of bonding polymer sheets according to claim 1 and a micro-fluidic device according to claim 18. Preferred or optional features of the invention are defined in the dependent claims.

The method of the invention is based on the surface activation of at least a portion of at least one of the polymer sheets, followed by a lamination procedure under pressure and soft heating below the melting temperature of the polymer sheets. The surface activation is achieved by exposure to a plasma and/or to a laser beam, resulting in active zones of the treated surface effecting an adhesive force between the polymer sheets when further put into contact under pressure and upon heating at a temperature below the melting or glass transition temperature of these polymer sheets. With this method, the fine two- and three-dimensional patterns are maintained upon sealing the surfaces, and the bulk polymer properties close to the bonded surfaces are preserved.

The method of this invention is used for the reproducible sealing of a polymer-based micro-structure or network of micro-structures. At least one of the polymer sheets contains 2 or 3-dimensional features that are not limited in size or shape, but that are in the millimeter, micrometer or lower scale. These micro-structures comprise a recess, a protruder, a hole, a channel or any combination thereof In this manner, the low temperature bonded micro-systems made of such micro-structures or network of micro-structures are designed to be filled with a fluid, thereby enabling separation, analysis, detection, synthesis, and the like. Such polymer micro-systems may therefore contain micro-channels, micro-spots, micro-wells, access holes and any other features conventionally used in micro-total analysis systems. As an example of application, the present invention may be used to bond two polymer layers (such as for instance two polyethylene terephthalate sheets or a polyimide foil with a polyethylene layer, etc.) that contains microstructures, without glue and at a low temperature. In this way, the microstructures can be assembled and then be used with an aggressive solvent without the risk of dissolution of glue or other adhesive layer. This could therefore serve as an aqueous or non-aqueous analytical system. Furthermore, the method can control the surface properties that can be used then for grafting molecules or generating very constant and non-Taylor-dispersed electroosmotic flow.

In one embodiment of the invention, the surface of at least one of the polymer sheets is modified using a chemical treatment so as to create functional groups on the surface that can further react. These functional groups may be created either to favor the bonding of the two polymer sheets by increasing the number of reactive sites or to enable the immobilization of a compound of interest prior to the bonding. In order to provide maximum bonding efficiency, this chemical activation step is normally performed after the step of activating a portion of one of the polymer surfaces by plasma and/or laser treatment and before the step of placing the two polymer sheets in contact under optimized pressure and temperature below the glass transition and/or melting temperature of said polymer sheets. In some cases, it may also be advantageous to treat one polymer sheet by plasma and/or laser activation and the other polymer sheet by chemical treatment. In many applications, an oxidative solution may be used to chemically modify the desired polymer surface. Indeed, with many polymer materials, such an oxidative treatment allows formation of oxygen functions such as e.g. carboxylic or alcoholic groups that can further react to favor the bonding. For instance, covalent and/or hydrogen bonds may be formed by placing in contact a polymer surface that has been chemically modified by an oxidative solution with a second polymer sheet that has been physically treated by a plasma or a laser beam in presence of oxygen. In another example, these oxygen functions may be used to covalently immobilize a compound on the polymer surface, as for example by creating an amide bond with a succinimide moiety.

In another embodiment, the method comprises the step of immobilizing a biological compound on at least a portion of one of the polymer sheets to be bonded. Indeed, as the present bonding method is a low temperature process, it may be advantageous to immobilize a biological compound prior to the sealing of the micro-structure. The biological compound may comprise a protein, an antigen, an antibody, an enzyme, an oligonucleotide or DNA, and can be immobilized either by physical or chemical adsorption or by covalent binding.

In a further embodiment, the step of placing the polymer sheets in contact comprises lamination between rollers, the rollers preferably being heated at a temperature below 200° C. This lamination step is preferably achieved in a lamination area which is separated from the plasma and/or laser treatment area. The controlled pressure and temperature of the laminating rollers ensure that the activated surface portion bonds to the second polymer sheet with strong adhesive forces. In one aspect of the invention, the polymer sheets are not heated before entering into contact with the rollers, so that neither of the polymer sheets reach its melting and/or glass transition temperature during this lamination step. In some applications, the polymer sheets are pressed between the heated rollers for only a short time period, so that their surfaces do not reach their glass transition and/or melting temperature even though the temperature of the rollers is set above this glass transition and/or melting temperature.

The polymer sheets may be placed in contact under the optimized pressure and temperature for less than 10 seconds, so as to prevent deactivation of said biological compounds immobilized on at least a portion of one of said polymer sheets.

As an example, the polymer sheet comprising the micro-structure or network of micro-structures may be immersed in a solution containing a biological compound of interest, such as e.g. an antibody, prior to laminating a second polymer sheet to seal the micro-structure. As the bonding step is achieved at a relatively low temperature and, normally in a short time, the immobilized compounds maintain their biological activity. These immobilized biological compounds can therefore be subsequently used to form a complex with another biological compound or to react with a substrate, as it is often the case in DNA, affinity or immunological tests.

In another embodiment, the method of this invention may be used to bond two polymer sheets made of the same material. This may for instance allow the creation of micro-systems wherein the substrate supporting the micro-structures and the roof used to seal them have the same surface properties, thereby providing systems with e.g. very low Taylor dispersion. This may also be advantageous for the manufacturing of polymer electrospray interfaces.

The method of the invention may be used to bond two polymer sheets made of a very low light absorbent material. In this manner, the method of the invention may be used to seal a micro-system without adhesive, so that e.g. luminescence can be employed as detection technique. The method of the invention may advantageously be used to bond e.g. polypropylene sheets that may not have the capability of thermal bonding at low temperature. In addition, in order to keep the particular optical properties of such a polymer, no glue or adhesive layer should be introduced because light can be absorbed at the interface between the polymer and the glue or adhesive layer, lowering the performance of the detection system.

The method of this invention can be used to bond two polymer sheets while maintaining after bonding their physio-chemical properties close to their surface, said properties being crystallinity, optical properties, elasticity, shape, conductivity and dielectric constant. For example, if patterns are printed on the surface of one polymer sheet, the method of this invention can be used to enable an efficient bonding with minimum distortion of the printed pattern. With the method of this invention, the fine geometrical characteristics of the micro-structures or of the other 3-dimensional features are also maintained upon sealing the two polymer sheets, and the bulk polymer properties close to the bonded surfaces are also preserved, thank to the low temperature of the entire bonding process. The method of this invention is also advantageously used when the polymer properties have to be homogeneous close to the surface. Indeed, it has been already demonstrated that intensive heating or local laser treatment change the crystallinity of the polymer and hence affect their properties. It is well known that excessive heating (for instance to bond material) can have dramatic effect on the surface properties, such as crystallinity, optical properties or surface tension, as the glass transition temperature may be exceeded. In the present invention, the bonding technology aims at maintaining the desired surface properties after the bonding because of the soft and homogeneous treatment performed. This avoids that some polymer materials that were soft before the bonding become fragile after this bonding. Another application is the microelectronic industry where bonding procedure should not destroy the properties of the polymer. Indeed some excessive treatment may induce a change in the dielectric property of a given polymer and should be avoided. In this case, the method of the present invention can also be advantageously employed.

In another embodiment, the method of this invention is further used to manufacture a multi-layer device by bonding more than two polymer sheets. This method may thus be advantageously used to fabricate three-dimensional micro-systems that can even contain micro-structures that are interconnected between two or more polymer layers.

At least one of the polymer sheets may contain features such as conductive tracks, optical waveguide and/or any other non-polymeric material. In a further embodiment, at least one of the polymer sheets may contain drawings, metallic tracks, other conductive materials, nanostructures or the like. For many applications, the method of the invention may indeed be used to seal a micro-system having integrated electrodes (that are made either in the micro-structures or in the sealing polymer foil). The fabrication of e.g. copper tracks coated with gold by electroplating is for instance well-known in the electronic industry for the fabrication of printed circuit boards. Such electrically conductive features may also used to form electrochemical micro-systems. The bonding of such systems according to the method of the present invention is also advantageous in this case since, as it is a low temperature process, no interdiffusion between the copper and the gold layer occurs during the sealing. This is of great advantage for electrochemical sensors, since interdiffusion generates copper on the electrode surface, and copper may be easily oxidized upon application of a potential thereby resulting in a current that masks the signal of interest.

In another embodiment, the step of activating a portion of at least one of the polymer surface is accomplished in-line with the step of putting the two polymer sheets in contact under optimized pressure and a temperature lower than the glass transition and/or melting temperature of these polymer sheets. Indeed, the surface portion which is activated by plasma and/or laser treatment contains chemical functions that are very reactive. It may thus be advantageous to prevent deactivation of this surface by limiting the time between the two above steps and hence limiting the exposure of this activated surface to air or any other atmosphere as well as limiting contact with any material other than the second polymer sheet to be bonded.

Another object of the present invention is to fabricate a device that is used in biological and/or chemical applications such as but not limited to electrophoresis, affinity assay, immunoassay, electrochemistry, chemical or biological synthesis, electrospray and/or a combination of them. In another embodiment, the device of this invention may be used for analytical and/or diagnostic applications such as but not limited to structures bonded by the technique described above where some part are dedicated to reactions, separation, detection, comprising or not space for microbeads with different functionalities such as proteins, antibodies, cation exchange material, reverse phase, enzyme, DNA or the like. In another aspect, the device of this invention is resistant to organic solvents. This means that the polymer sheets are selected to resist to a given solvent and that the bonding of the activated polymer surface is strong enough to resist such solvent, thereby preventing any leakage of liquid.

### BRIEF DESCRIPTION OF THE DRAWINGS

Embodiments of the invention are hereinafter described in more detail by way of examples only, with reference to the attached figures, in which:

FIG. 1 is a scanning electron microscope (SEM) picture of the cross-section of a polymeric sheet prior to bonding;

FIG. 2 is an SEM picture of the cross-section of the sheet 2 of FIG. 1 after bonding with a second sheet using the method of the invention, FIGS. 3 and 4 are a schematic drawing and an SEM picture respectively of the cross-section of a microchannel laminated according to the conventional method;

FIG. 5 is a graph showing the evolution of the electroosmotic flow rate in various types of micro-structures that have been bonded using the method of this invention or otherwise;

FIG. 6 is a fluorescence image of the electrokinetic injection of fluorescein in a micro-structure sealed with the method of the present invention;

FIG. 7 is a graph representing an electropherogram obtained with a microchip made of bonded PET sheets according to the present invention;

FIG. 8A shows the intensity of the total mass signal as a function of time obtained by exposing a microchannel similar to that of FIG. 2 to a mass spectrometer for spraying a sample of 4 μM of myoglobine;

FIG. 8B shows the entire mass spectrum of myoglobine obtained; and

FIG. 9 is a photograph showing the torn polymer layers after a tensile strength delamination experiment.

### DETAILED DESCRIPTION OF THE PREFERRED EMBODIMENTS

In order to demonstrate the method of the present invention, the bonding of two polyethylene terephthalate (PET) plates is achieved. The two plates are placed in an oxygen plasma stripper during typically 15 seconds under a power of 200 to 500 W at a temperature of about 30° C. The two plates are then placed in contact and rolled under a laminator at 130° C. The sealing is therefore achieved far below the melting temperature. This last fact facilitates the bonding of polymer plates with microstructures without any loss in the shape of such three-dimensional patterns as presented in Example 1.

### EXAMPLE 1

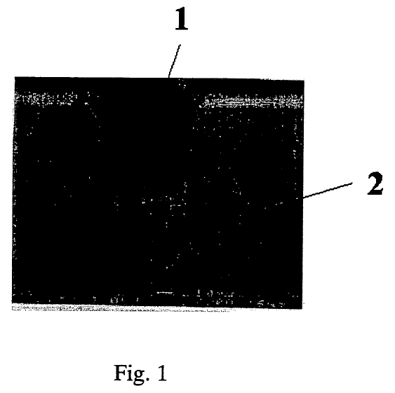

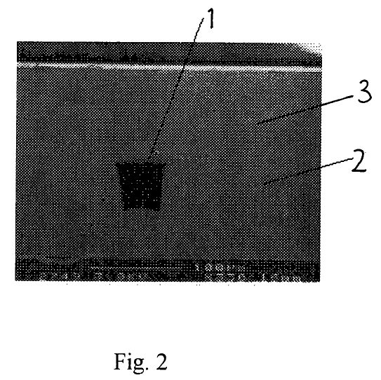

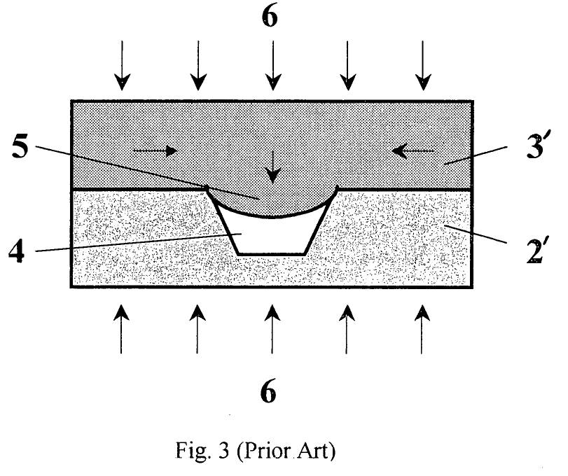

FIG. 1 shows a SEM picture, before bonding, of a microchannel 1 measuring 40×60 μm² fabricated by laser photoablation of a polyethylene terephthalate (PET) sheet 2 (100 μm thick, Melinex). This sheet and another non-structured PET plate are activated by plasma for 15 seconds Both sheets are then laminated together using a conventional lamination machine (Morane). FIG. 2 shows a SEM picture of the sealed microchannel 1 created by the bonding of the micro-structured PET sheet 2 with the second PET sheet 3 following the method of this invention. It is remarkable to see that the interface between both polymer sheets is not visible after the bonding, meaning that the bonding is perfectly achieved. Such a bonding process is thus perfectly suited for the sealing of micro-structures patterned in a polymer, since it has been tested that no leakage appears even upon exposure of the micro-structure to pressure.

It should be borne in mind at this stage that one of the key problem in the fabrication of miniaturized systems is to obtain highly reproducible microstructures. Indeed, many reactions and analyses strongly depend on the volume in which they take place. In assays based on luminescence detection, the signal obtained directly depends on the path length of the light and hence on the geometry of the system. In affinity assays that are based on the formation of a specific complex (generally between two proteins or between an antigen and an antibody), this complexation reaction generally occurs with one moiety immobilized on the walls of the reaction chamber. Variations in the volume of this reaction chamber therefore modify the number of immobilized molecules and hence of complexes formed, which therefore affects the signal that can finally be detected. Changes in the reaction volume may thus produce significant irreproducibility, which is not acceptable for reliable testing as e.g. required in diagnostic applications.

The procedure used to seal polymer micro-structures may have a very large impact on the quality of the measurement. Indeed, micro-structures are very often sealed by covering a plastics layer onto the polymer sheet supporting the microstructures. In this process, the two polymer sheets are generally placed in contact under heating and pressure using e.g. a lamination machine. The advantage of such a process is that it prevents the use of adhesives that could dissolve in the sample solution and disturb the reactions and analysis. The main disadvantage however relies on the fact that this process necessitates attaining a temperature where the polymer sheet with the lower melting point begins to melt. As pressure needs to be applied to the two polymer sheets in order to ensure a sufficiently strong bonding, the melted portion of the polymer sheets is deformed.

We have for instance observed that an important portion of a microchannel can be partially obstructed by the conventionally laminated polymer. As schematically shown in FIG. 3, when a lamination layer 3′ is heated at a temperature close or superior to its melting temperature, the applied pressure 6 deforms this lamination (as shown by the arrows within layer 3′) which tends to penetrate into the microstructured groove or microchannel 4, thereby resulting in an obstruction 5 of the sealed microchannel 4. It is then very difficult to control this obstruction and hence the volume of the sealed micro-channel. FIG. 4 shows an example of cross-section of a microchannel made where the polymer substrate is a polyimide foil 2′ and where the bonded PE/PET layer 3′ has been bonded by lamination at the melting temperature of the polyethylene layer which is in contact with the polyimide foil, thereby producing an obstruction 5 which modifies the depth of the micro-channel 4. It should be stressed at this point that we have also observed that this bonding is not regular over the entire channel length and that it is not reproducible from one channel to another. This is very likely to be due to the fact that the temperature is not uniform in the entire polymer sheet, so that some parts of the sheet melt more than others. After much effort, we have discovered that certain irreproducibilities of the measurements taken from laminated microstructures were due to such deformations.

It has thus been one object of the present invention to find a way to seal micro-structures with high reproducibility. As the laser and/or plasma treatment of the present invention allows the creation of functional groups on the surface of the polymer sheets that favor their bonding, it is then possible to expose them to lower temperatures, thereby preventing deformations similar to those observed with conventional lamination processes. Indeed, one key feature of the present invention is that activating the surface upon laser or plasma exposition allows to bond two polymer sheets below their melting temperature.

FIG. 2 shows an example of a structure in which the laminated layer 3 does not bind and hence does not partially obstruct the micro-channel. In such systems, the laminated bonding layer does not show any deformation, so that the volume of the reaction chamber depends only on the accuracy of the micro-fabrication process. Micro-systems sealed with the method of the present invention therefore show the advantage of better geometrical control than conventional sealing methods.

Furthermore, it has been noted that the bonding strength is improved by such laser or plasma activation treatment. Indeed, higher pressures can then be applied in the microstructures, which allows higher flow rates. Also, such bonding is resistant to more aggressive solvents, which allows novel applications of micro-systems compared to conventional lamination techniques (e.g. use of acetonitrile or highly acidic solutions for electrospray coupling to a mass spectrometer).

It should be pointed out that plasma and/or laser activation may not be suitable for all kinds of polymers. With the laser and plasma oven used, and under the conditions chosen for our experiments, it has been demonstrated that the bonding of a polyimide micro-structure with a polyethylene/polyethylene terephthalate sheet was of optimum efficiency in terms of strength, absence of deformation and resistance to solvents. On the other hand, the bonding of two polyimide sheets was not significantly improved by activation under an oxygen plasma. This is very likely to be due to the experimental conditions used, where neither the gas mixture of the plasma, nor the exposition time and the energy were optimized. For industrial applications, it will thus be necessary to establish for each type of polymer the activation parameters and the conditions that allow the optimal bonding, while maintaining the geometrical accuracy and repeatability of the sealed micro-systems.

### EXAMPLE 2

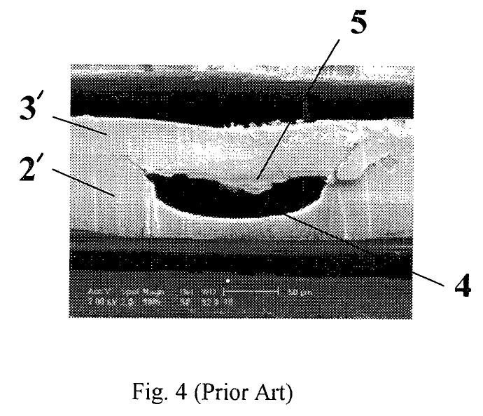

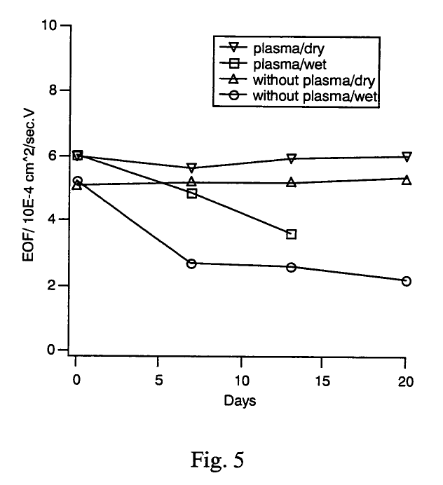

In the present example, the bonding method of this invention is used to seal microstructures patterned in one polymer sheet, so as to produce a micro-analytical system. To this aim, a microchannel similar to that shown in FIGS. 1 and 2 is generated in a PET sheet by laser photoablation. After bonding following the process described above, the sealed microchannels are used to demonstrate that an electroosmotic flow can be generated in such microstructures. The time required for the solution to travel the length of a 2 cm long micro-channel is presented in Table 1 for a series of 6 tests. Similarly, FIG. 5 shows the values of the electroosmotic flow obtained in various types of micro-channels and compares the values obtained in plasma treated and non-treated PET sheets as a function of time.

It is remarkable to observe that no leakage is observed during the measurement, showing the good bonding property developed, despite the low temperature at which it is achieved.

| Test No | 1 | 2 | 3 | 4 | 5 | 6 | Average |
|---|---|---|---|---|---|---|---|
| Time | 19.1 | 19.6 | 19.6 | 20.1 | 20.3 | 20.5 | 19.9 |
| in seconds | | | | | | | RSD(2.6%) |

Table 1. Repeatability of the electroosmotic flow in homogeneous PET micro-channels sealed by the method of the present invention (15 seconds exposure to an oxygen plasma at 350 W, before lamination at 130° C). The table shows the time (in seconds) required by a 13.4 mM phosphate buffer solution at pH 7 to flow along a 2 cm long micro-channel.

The bonding also showed good resistance to pressure. Indeed, it has been demonstrated that one can easily pump a fluid in such sealed microchannels without any leakage, and this is the object of Example 3 below.

### EXAMPLE 3

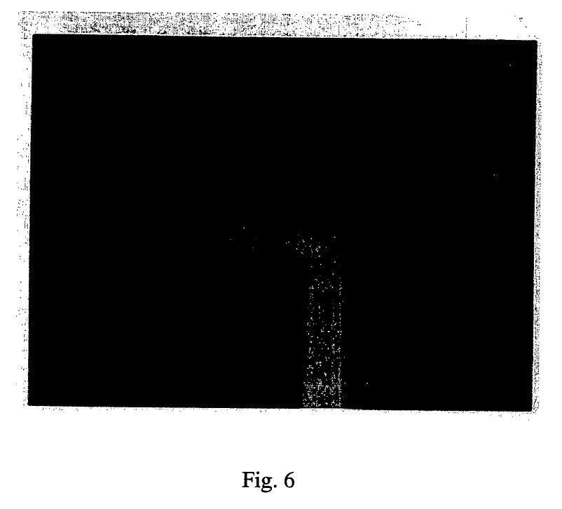

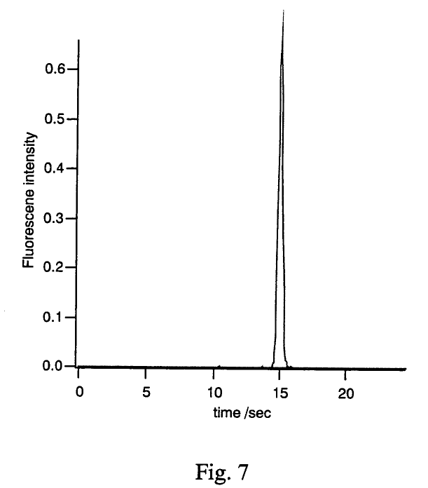

The PET microchannels generated following the method of the present invention are further used to design an electrophoresis device with a double T injection pattern. FIG. 6, which is a fluorescence image of the electrokinetic injection of fluorescein, shows that no leakage occurs since no trace of fluorescein can be seen. Electrophoretic separation is illustrated by the injection and detection of a fluorescein plug and reported in the electropherogram of FIG. 7. The obtained peak is due to the fluorescence detection of fluorescein

### EXAMPLE 4

In order to enable the analysis of protein solution by Mass Spectrometry, solvent and/or acidic solution can be used such as methanol, acetonitrile and strong acids. In order to enable the use of the microchips as nano-electrospray tips, the materials in use for the fabrication of the chips must be compatible with the strongly acidic spraying solution. Therefore, using a composite channel or glue may provide some incompatibilities with the solvent and contaminate the spectrum obtained with the nano-electrospray. The chip presented in FIG. 2 and composed of PET is therefore used to obtain a mass spectrometry spectrum with a Finnigan LCQ duo Mass Spectrometer. The chip is exposed to the mass spectrometer and a tension of 1 to 2 kV is applied between the mass spectrometer entry and a reservoir made in the microchip that is filled with 50% Methanol 49% Water and 1% acetic acid.

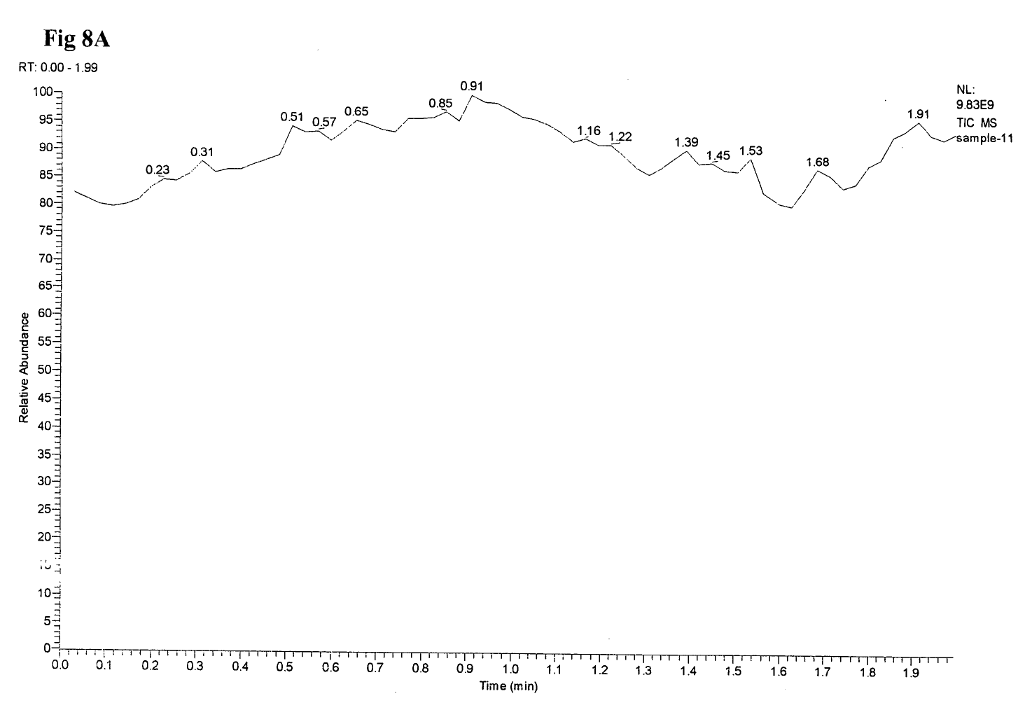

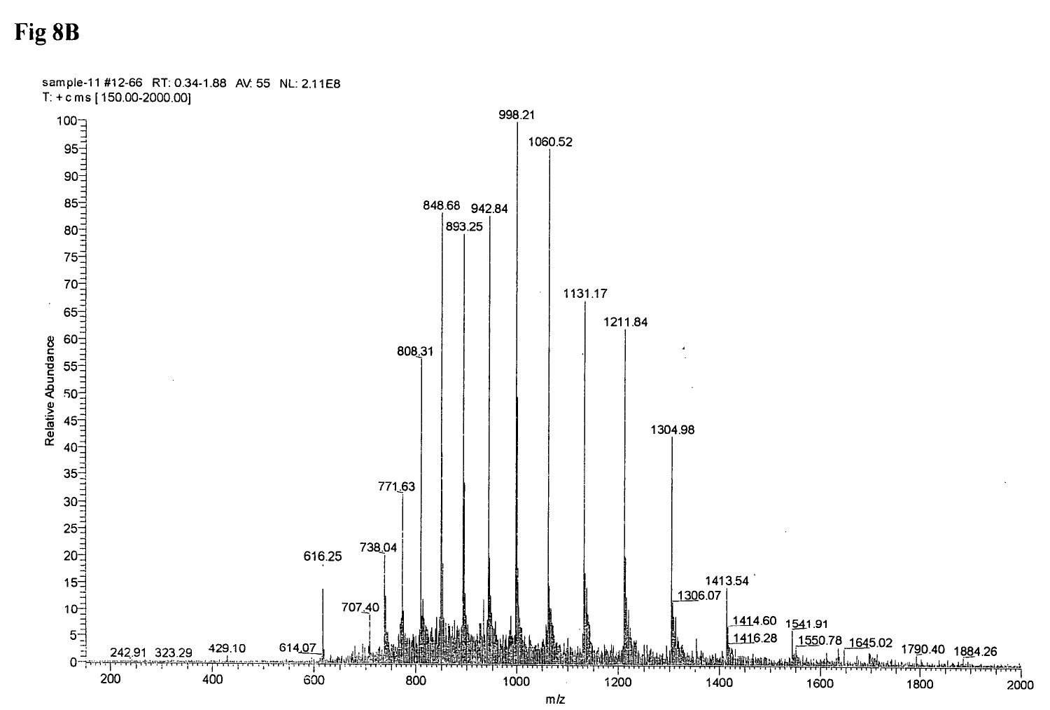

FIG. 8A shows the evolution of the total abundance of the peaks of myoglobine with time and FIG. 8B shows the spectrum of myoglobine. The accuracy of this spectrum as well as its stability upon time demonstrate the feasibility of the method of this invention to prevent contamination.

### EXAMPLE 5

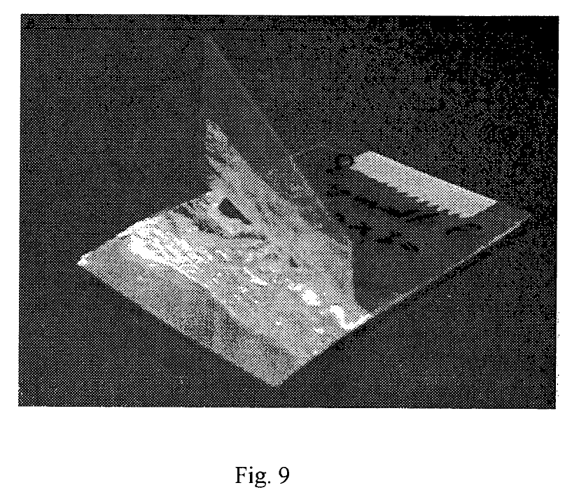

As evidence of the good sealing property of the present bonding procedure, delamination has been tested to evaluate the tensile force needed for separating the two bonded PET layers. FIG. 9 shows that it is not possible to separate the two bonded layers, since this process destroys the entire structure. If more pressure is applied, the plastic will be torn instead of delaminated.

1. A low temperature method of bonding two carbon-based polymer sheets without adhesive, at least one of said polymer sheets comprising a microstructure or a network of microstructures, said low temperature method being suitable for bonding thin polymer foils and comprising the steps of:
(a) treating at least a portion of one surface of one of said polymer sheets by using a cold plasma or a laser beam so as to physically activate said portion at low temperature;
(b) placing the two polymer sheets in contact, with the activated portion of said one sheet in contact with the other sheet; and
(c) subjecting said sheets to a pressure of from 1 to 10 bar and to a temperature below the melting and/or glass transition temperature of either of said polymer sheets, thereby bonding said sheets and forming a sealed micro-structure and/or network of micro-structures.

2. A method according to claim 1, comprising also treating at least a portion of said other sheet by using a cold plasma or a laser beam so as to physically activate said portion at low temperature; and wherein in step (b) the two activated portions are placed in contact.

3. A method according to claim 1 or 2, wherein said microstructure and/or said network of microstructures comprises a recess, a protrusion, a hole, a channel and/or a combination thereof.

4. A method according to claim 1, 2 or 3, further comprising the step of chemically modifying at least a portion of one surface of at least one of said polymer sheets so as to change the surface properties of said portion.

5. A method according to claim 4, wherein said step of chemically modifying at least a portion of one surface comprises the use of an oxidative solution.

6. A method according to any preceding claim, further comprising the step of immobilizing a biological compound on at least a portion of at least one of said polymer sheets by physical or chemical adsorption or covalent bonding.

7. A method according to claim 6, wherein said biological compound is a protein, an antigen, an antibody, an enzyme, an oligonucleotide or DNA.

8. A method according to claim 5 or 6, wherein said polymer sheets are subjected to pressure and temperature for less than 10 seconds, so as to prevent deactivation of said biological compound.

9. A method according to any preceding claim, wherein the steps of placing said two polymer sheets in contact and subjecting to pressure and temperature are achieved by lamination between rollers.

10. A method according to claim 9, wherein said rollers have a temperature below 200° C.

11. A method according to any preceding claim, wherein the two polymer sheets are of the same material.

12. A method according to any preceding claim, wherein said two polymer sheets are made of a very low light absorbent material.

13. A method according to any preceding claim, wherein more than two polymer sheets are bonded together so as to build a multilayer device.

14. A method according to any preceding claim, wherein at least one of said polymer sheets contains at least one non-polymeric feature.

15. A method according to claim 14, wherein the non-polymeric feature is selected from a conductive track, an optical waveguide, a drawing, and a nanostructure.

16. A method according to any preceding claim, wherein at least those parts of the polymeric sheets arranged to delimit the sealed micro-structure and/or network of micro-structures are resistant to organic solvents.

17. A method according to any preceding claim, comprising fabricating a micro-fluidic device for use in biological and/or chemical applications.

18. A micro-fluidic device comprising two polymeric sheets bonded together without adhesive, at least one of said sheets comprising a recessed microstructure sealed by the other bonded sheet such that said other bonded sheet does not protrude into the microstructure.

19. A device according to claim 18, comprising at least one part dedicated to reactions, separation, detection or the uptake or dispensing of a sample.

20. A device according to claim 19, wherein said at least one part comprises a space for microbeads with one or more functionalities selected from proteins, antibodies, cation exchange material, reverse phase, enzyme, or DNA.

21. A device according to claim 18, 19 or 20 that is resistant to organic solvents.

22. Use of the device according to any one of claims 18 to 21 in an analytical or diagnostic technique comprising at least one of electrophoresis, affinity assay, immunoassay, electrochemistry, chemical or biological synthesis, electrospraying and a combination thereof.
